(19) United States
(12) Patent Application Publication
(10) Pub. No.: US 2011/0224812 A1
(43) Pub. Date: Sep. 15, 2011

(54) METHOD AND ARRANGEMENT FOR THE AUTOMATIC OPTIMIZATION OF THE TRANSFER FUNCTION OF A LOUDSPEAKER SYSTEM

(76) Inventor: Daniel Kotulla, Straubing (DE)

(21) Appl. No.: 13/126,977

(22) PCT Filed: Oct. 29, 2009
(86) PCT No.: PCT/EP09/64315

§ 371 Date: May 27, 2011

(30) Foreign Application Priority Data
Oct. 29, 2008 (DE) 10-2008-053-721.7

(51) Int. Cl. G06F 17/00

(52) U.S. Cl. 700/94

(57) ABSTRACT

In the case of a method for optimizing the transfer behavior of loudspeaker systems in a consumer electronics device, the actual transfer function of the loudspeaker system to be optimized is determined, in that a test signal is reproduced on the loudspeaker system either directly or via audio signal processing stages (DSP, amplifier, etc.) installed in the device, and the acoustic signal emitted by the loudspeaker system is captured by means of microphone and the actual transfer function is determined from the measurement values. Furthermore, in the method, a code for a DSP algorithm is generated and optimized to the extent that, in the case of a previously set maximum deviation from the desired transfer function, the fewest DSP resources are needed. The completely optimized code is loaded into the DSP of the device and activated. A corresponding arrangement has a microphone, a measurement unit, a DSP code generator, and an interface that loads the generated DSP code into the connected consumer electronics devices.

### PRIORITY INFORMATION

This patent application claims priority from PCT patent application PCT/EP2009/064315 filed Oct. 29, 2009, which claims priority to DE patent application 10 2008 053 721.7 filed Oct. 29, 2008, both of which are hereby incorporated by reference.

### BACKGROUND OF THE INVENTION

The sound of a loudspeaker is defined, in large part, by the geometry of the housing in which it is installed. Low-pitched sounds can be transferred in good quality, for example, only with correspondingly large housing dimensions. Flat panel TVs, that is, television sets with flat screens, e.g., using LCD or plasma technology, are very limited in their dimensions due to design specifications and therefore do not allow a large housing volume for the installed loudspeaker. On the other hand, for visual reasons, very small and economical loudspeakers are often used whose transfer functions lead to especially unnatural sound. Other devices of consumer electronics, however, are also subject to structurally related limitations when it concerns equipping with loudspeakers.

Television sets and other consumer electronics devices today already have a plurality of components integrated for signal processing (e.g., digital signal processors, DSPs). It is therefore desirable to use these already existing elements for corrections.

Methods are known that define the impulse response of a loudspeaker by various methods and generate an inverse filter that corrects the non-ideal impulse response. In these methods, however, an experienced operator is needed in order to perform the measurements and to manage a plurality of setting possibilities. This operator should also have, in particular, acoustic experience, in order to be able to correctly judge the measurement results and the effects of the settings.

International Application WO2006123923A1 describes a method in which, through uniform movement of the microphone in front of the loudspeaker to be measured, many discrete measurements are made, in order to obtain the so-called “Acoustic Power Frequency Response” that is then used as a basis for calculating corresponding correction values. In this method, it is attempted to remove through calculation the influence of the space in which measurements are performed through complicated calculations by a Fast Fourier Transformation (FFT), inverse FFT, and statistical methods.

These methods require a considerable expenditure both in measurement time due to the plurality of points and also for the calculations. Therefore, they are not suitable, e.g., for an implementation on a semiconductor as is typical in modern television sets.

U.S. Pat. No. 6,760,451 describes a method in which, from a measurement, the frequency response of the loudspeaker is determined by a smoothing in the frequency range, wherein the smoothing should be variable across the frequency. A disadvantage here is that, through the smoothing, sharp peaks in the frequency response may be evaluated incorrectly and may thus lead to an incorrect correction.

European Patent EP624947B1 describes a method in which an operator sets the correction values on the basis of measurement values that are shown on a display simultaneously with the desired values. This method is susceptible to errors and is not completely automatic.

### SUMMARY OF THE INVENTION

The present invention therefore creates a method that optimizes the transfer behavior of such loudspeakers or loudspeaker systems in a completely automatic process. The invention further creates an arrangement with which the transfer behavior by loudspeakers or loudspeaker systems in consumer electronics devices can be optimized in an automated process.

A method for optimization of the transfer behavior of loudspeakers in a consumer electronics device includes

A. the actual transfer function of the loudspeaker system to be optimized is determined in that:

aa) a test signal is reproduced on the loudspeaker system either directly or via the audio signal processing stages (DSP, amplifier, etc.) installed in the device,

ab) the acoustic signal emitted by the loudspeaker system is captured by a microphone and the actual transfer function is determined from the measurement values;

B. a code for a DSP algorithm is generated and optimized to the extent that the fewest

DSP resources are needed in the case of a previously set maximum deviation from the desired transfer function,

C. the completely optimized code is loaded into the DSP of the device and activated.

Preferably, the method runs completely automatically.

The code for the DSP algorithm may be selected from a plurality of prepared codes for DSP algorithms. Here, a code is selected with which, for the measured actual transfer function, a specified desired transfer function can be realized with the DSP of the device. To this end, in a code library, a plurality of possible codes for DSP algorithms may be prepared that describe, e.g., an IIR filter, FIR filter, a DSP code for a graphical or parametric equalizer. The algorithms may also be stored in the library in the form of a metacode from which a DSP code is generated.

The optimization of the code may be performed in such a manner that, alternatively or in combination,
it is recognized whether, in the case of the selected algorithm, symmetries exist with respect to filter coefficients, in which case the code is optimized so that coefficients that appear twice must be stored only once in the data storage device, in order to optimize the storage device;
it is recognized whether, in the case of a stereo measurement, the measured transfer function of both channels is nearly equal and thus may be corrected by two identical filters/equalizers, in which case the code is optimized so that common coefficients are used for multiple channels;
it is recognized whether it is more favorable by the available resources to place coefficients for the selected algorithm either into data RAM or into program RAM.

The optimization of the code may be performed recursively in multiple passes without further measurement-value determination.

Additional measurements may be performed with reference to which the changed transfer response of the loudspeaker system is checked and the DSP code is confirmed, rejected, or changed accordingly. Optionally, through a repetition of the steps, the DSP code may be optimized until the transfer response corresponds to the desired result or a different break condition is reached, e.g., maximum specified processing time or number of repetitions.

The optimization of the code may be performed starting from the information on the available resources, e.g., program RAM, data RAM, computing power MIPS (Mega-Instructions Per Second). This information may be made available in advance, if it is known from the configuration of the device. However, the information may also be read out from the device, e.g., by a user interface. Especially advantageously, available resources are read out by a suitable user interface directly from the DSP in the application operation, i.e., when the functions for sound processing provided for the device are already implemented and activated in the DSP. This is advantageous especially when the DSP allocates the resources dynamically.

The code may be optimized with respect to the quantization of the coefficients or the data. This means that the accuracy of the coefficients is selected only as large as is needed for achieving the desired transfer function. For example, a 12-bit accurate coefficient needs less memory than a 24-bit coefficient. In this way, either data or program RAM can be saved according to the architecture of the DSP.

The DSP code generation and the control and evaluation of the measurements may be combined in a common program.

A system for automatic optimization may include a microphone, a measurement unit, a DSP code generator, and an interface. The microphone captures an acoustic test signal reproduced by a loudspeaker system of a consumer electronics device, converts it into an electrical measurement signal, and forwards it to the measurement unit. The measurement unit calculates, from the measurement signal, the transfer function of the loudspeaker system and prepares it for the DSP code generator. The DSP code generator generates, from a plurality of possible DSP algorithms, a code for a DSP algorithm that needs the fewest DSP resources for a previously set maximum deviation from the desired transfer function, and the interface loads the generated DSP code into the connected consumer electronics devices.

The system may include a library of codes of possible DSP algorithms from which the DSP code generator selects codes.

The system may include information on the available resources (program RAM, data RAM, computing power MIPS) of the DSP in the connected consumer electronics devices.

The system may include a user interface for the input of information on available resources (program RAM, data RAM, computing power MIPS) of the DSP.

Other advantageous constructions of the invention emerge from the following description of preferred embodiments with respect to the accompanying drawings in which are shown:

### BRIEF DESCRIPTION OF THE DRAWINGS

FIG. 1, a schematic representation of an arrangement according to one embodiment of the invention,

FIG. 2, a schematic, functional representation of a method according to the invention,

FIG. 3, a schematic representation of an arrangement according to one advantageous refinement of the invention, and

FIG. 4A and FIG. 4B, schematic representations of a microphone arrangement according to the embodiment according to FIG. 3.

### DETAILED DESCRIPTION OF THE INVENTION

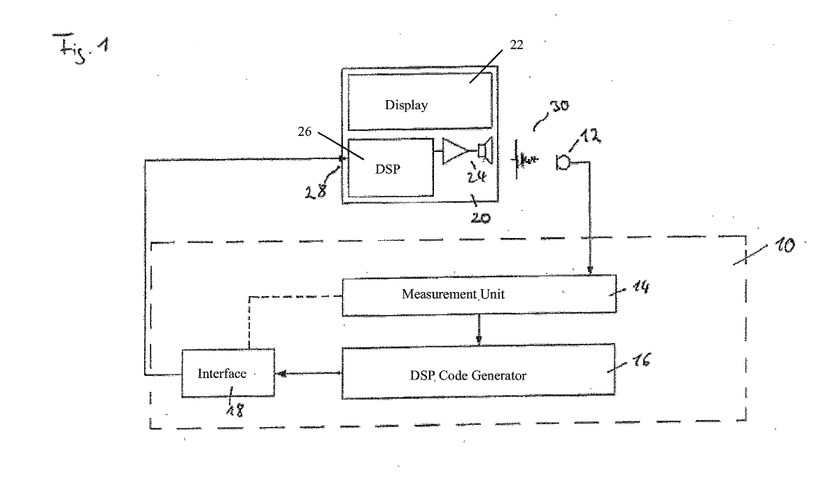

FIG. 1 shows a first embodiment of a system 10 that includes a microphone 12, a measurement unit 14, a DSP code generator 16, and an interface 18. FIG. 1 also shows a consumer electronics device in the form of a flat screen TV set 20 with a display 22, a loudspeaker system 24, and a digital signal processor (DSP) 26 with a service interface 28. In the DSP, functions are implemented in a known way that are used for the preparation of electrical audio signals for reproduction by the loudspeaker 24, e.g., functions for influencing the color tone and for supporting multi-channel and surround-sound effects.

The microphone 12 captures an acoustic test signal 30 reproduced by the loudspeaker system 24 and converts this into an electrical measurement signal. The microphone 12 is connected to the measurement unit 14 to which it forwards the electrical measurement signal. The measurement unit 14 calculates from the measurement signal the transfer function of the loudspeaker system 24 by methods known to someone skilled in the art and prepares the transfer function for the DSP code generator 16. DSP code generator generates, from a plurality of possible DSP algorithms, a code for a DSP algorithm that needs the fewest DSP resources in the case of a previously set maximum deviation from the desired transfer function. The interface 18 is connected to the service interface 28 of the TV set, in order to load the generated DSP code into the connected TV set 20.

The microphone 12 is advantageously arranged so that it captures the test signals in the direct field of the loudspeaker 24. The direct field is the area within the Hall radius rH in which the influence of the area is minimized. In the acoustics in a closed space, the Hall radius or Hall distance rH is that range from the sound source Q at which the direct sound level LD is equal to the room sound level LR in the static sound field. The direct field is not to be confused with the near field (<10 cm) that is normally used for the measurement of low-pitched tones. In the case of the direct-field measurement, the calculation of the frequency response of a loudspeaker can thus be simplified, because the influence of the space does not have to be calculated through complicated mathematical methods after the measurement.

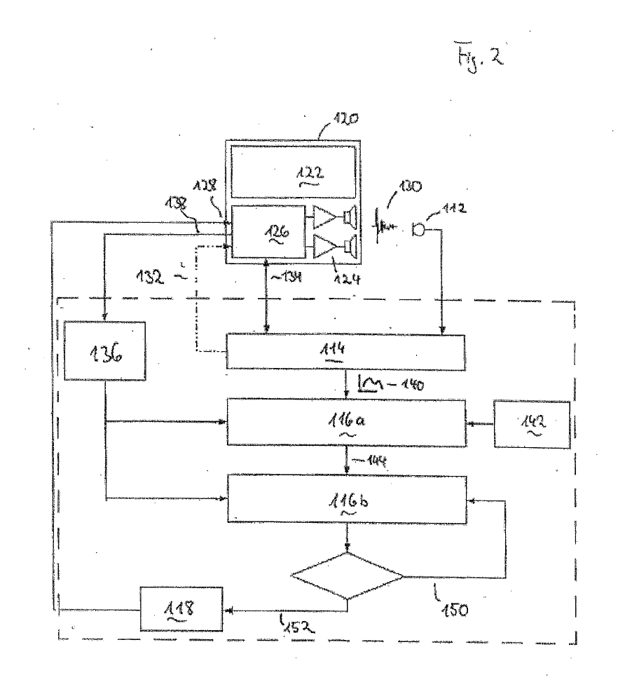

In a symbolic functional representation, FIG. 2 illustrates an embodiment of the method according to the invention. In the description, reference symbols increased by 100 are used for already known elements. According to the method, in a first step 114, the actual transfer function 140 of the loudspeaker system 124 to be calibrated is calculated, in that an electrical test signal 132 is given to the loudspeaker system 124 either directly or via the signal processing stages (DSP 126, amplifier, etc.) installed in the television set 120, the acoustic signal 130 output by the loudspeaker system is captured with the microphone 112. The transfer function is calculated by the measurement unit through known measurement algorithms from the measurement values.

The electrical test signal 132 can be prepared by the arrangement according to the invention, especially by the measurement unit, and can be fed to the DSP 126 via the service interface 128 or via a separate interface. The electrical signal, however, may also be generated in the television set 120, in particular, in the DSP 126, or may be fed externally to the television set, e.g., by a test signal generator (not shown). A direct feeding of the test signal from the arrangement in the loudspeaker system 124 is also conceivable.

Advantageously, the output of the test signal 130 from the arrangement, in particular, from the measurement unit, may be controlled by the service interface 128 or by a separate interface 134.

Advantageously, the DSP code generator may read out information 136 on the resources available in DSP 126 (e.g., available program memory, data memory, computing power), e.g., by the service interface 128 or by a separate interface 138. With reference to the information 136 on the resources and the transfer function 140 that is provided by the measurement unit, in another step 116a, the code generator can advantageously select, from a code library 142, possible codes 144 that provide functions for optimizing the transfer function of the loudspeaker 124 in DSP 126. The code library 142 may include a plurality of possible DSP algorithms that describe, e.g., an IIR filter, FIR filter, a DSP code for a graphical or parametric equalizer. The algorithms may also be stored in the library in the form of a metacode from which the code generator generates a DSP code. The selection may take place with consideration of with which codes or metacodes the desired transfer functions may be implemented. Here it is already considered, as much as possible, that for a previously set maximum deviation from the desired transfer function, as few as possible or, in any case, no more DSP resources are used than are available.

In another step 116b, the code is optimized to the extent that for previously set maximum deviations from the desired transfer function, as few as possible or, in any case, no more DSP resources are used than are available. Furthermore, the DSP code is optimized so that, starting from the information 136 on the available resources
it is recognized whether, in the case of the selected algorithm, symmetries exist with respect to filter coefficients; if this is the case, then the code is optimized so that coefficients that appear twice must be stored only once in data memory, in order to optimize memory;
it is recognized whether, in the case of a multi-channel measurement, the measured transfer function of the channels is nearly equal and thus can be corrected sufficiently accurately by two identical filters/equalizers. In this case, the code is optimized so that common coefficients are used for multiple channels;
it is recognized that it is more favorable by the available resources to place coefficients for the selected algorithm either into data RAM or into program RAM.

Finally, the completely optimized code 152 is loaded via the interfaces 118, 128 into the DSP 126 of the television set 120 and activated, so that the sound reproduction by the loudspeaker system takes place from now on with the changed transfer function.

Advantageously, the optimization 116b of the code is performed recursively in multiple passes 150 without further measurement-value determination.

Even more advantageously, additional measurements may be performed with reference to which the changed transfer behavior of the loudspeaker system is checked and the DSP is confirmed, rejected, or changed accordingly. In addition, through a repetition of the steps, the DSP code may be optimized until the transfer behavior corresponds to the desired result or a different break condition is reached, e.g., maximum specified processing time or number of repetitions.

In addition, the code generator 116 may perform an optimization of the code with respect to quantization (accuracy) of the coefficients or the data.

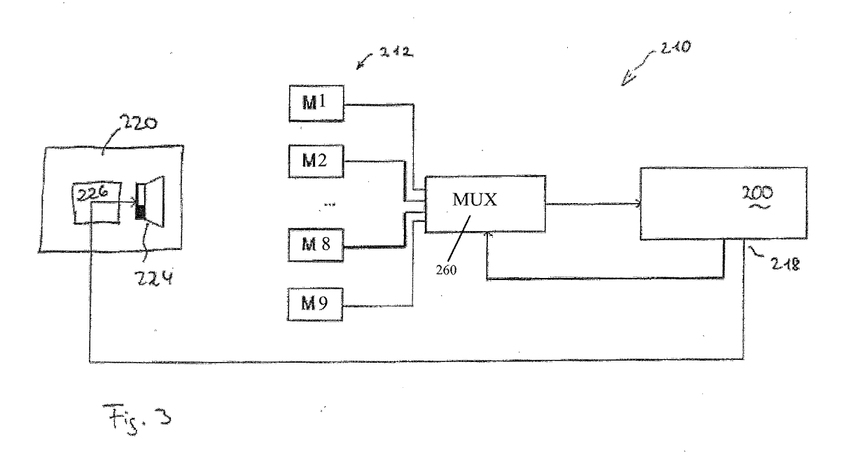

FIG. 3 shows schematically an arrangement according to an advantageous refinement of the invention that realizes an arrangement and a method according to the invention. In the case of the description, reference symbols increased by 200 are used for already known elements.

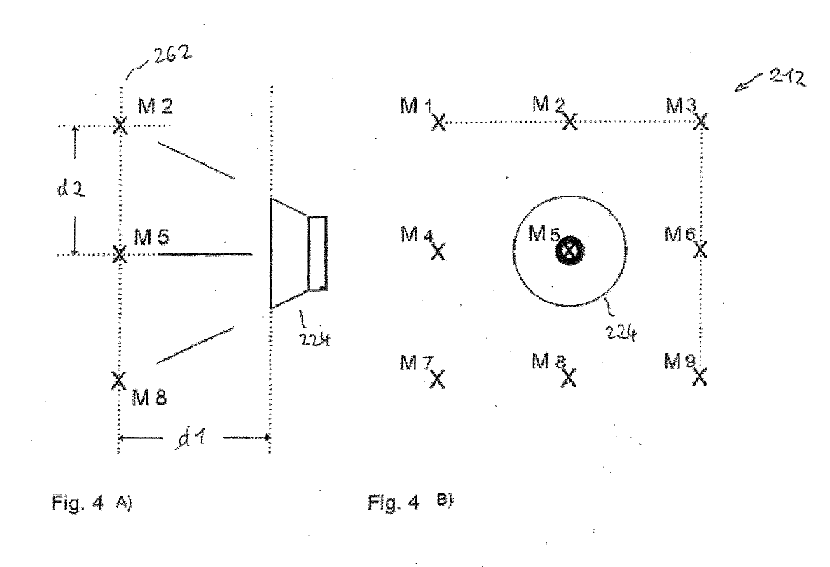

The representation shows an arrangement 210 with a computational unit 200, measurement unit, DSP code generator, and interface 218, as contained from the preceding embodiment in a known way. Instead of an individual microphone, the arrangement 210 has an array 212 of microphones M1-M9 that are connected by a multiplexer 260 to the measurement unit. The microphones are arranged, as shown in FIGS. 4A and 4B, in the form of a 3×3 grid in a plane 262 in front of a loudspeaker 224 of a television set 220 with DSP 226. Here, the middle microphone M5 is located approximately in the middle in front of the loudspeaker 224.

For determining the transfer function of the loudspeaker 224, in this embodiment, the multiplexer 260 is controlled by the computational unit 200, so that each of the microphones of the array 212 are connected to the measurement unit, while each or several of the acoustic test signals 230 are reproduced by the loudspeaker 224. After all of the measurement points are captured, the reproduction of the test signal is stopped automatically. Through an averaging across all of the measurement points, the measurement errors of the individual measurements are reduced. Thus, measurement errors can be avoided that are produced based on the position of each microphone, i.e., in this way, certain frequencies due to acoustic conditions at each location are especially damped or reinforced. The averaging preferably does not take place in the time domain, but instead in the frequency domain, that is, with the Fourier-transformed signals.

The distance d1 of the plane of the array from the loudspeaker plane 264 is selected so that the microphones are located in the direct field of the loudspeaker, so that an influence of the room acoustics can be ruled out in a simple way. On the other hand, it should also be avoided to set up the microphones in the near field of the loudspeaker, because there the acoustics are not representative for the transfer function of the loudspeaker 224. A distance d1 between 30 and 50 cm is preferred. The same considerations apply for the distance d2 of the microphones among each other. Other arrangements of the microphones are also possible, also non-symmetrical and other numbers of microphones. Here, it is to be balanced that with more microphones, errors of individual microphones are more strongly suppressed, but, on the other hand, the measurement period and the calculation time increase. It is also possible to use only one or a few microphones and to mechanically shift these between the measurements, e.g., by an automatic device, from one position into another.

The computational unit 200, or each or several of the elements of measurement unit, code generator, and interface of all of the embodiments may be constructed as hardware circuitry or as instructions in a program for a configurable computational unit, e.g., a microcontroller, PC, or also as an FPGA, which are loaded, when needed, into the computational unit.

The DSP code generation and the control and evaluation of the measurements are advantageously combined in a common program.

Another possibility consists in that, in this method, infrastructure already present, e.g., in the flat-panel TV is used, in part, by the elements already described in the preceding embodiments (e.g., microphone input, DSP, amplifier) or the entire method is performed in a DSP integrated in the TV. Thus, for example, the computational unit 200 may be integrated in hardware in the television set or may be realized as software in the DSP 26 or in another already present computational unit. In order to not additionally load the DSP in normal operation, this software may be advantageously stored in a ROM and loaded when needed or it may be loaded from an external data memory.

The proposed method and the arrangement offer a simple possibility of adapting the transfer quality of a loudspeaker system to a manufacturer of devices of consumer electronics. The method may be used in an automated way without operator intervention, for example, on an assembly line.

What is claimed is:

1. Method for optimization of the transfer behavior of loudspeaker systems in a consumer electronics device comprising the steps of:
determining the transfer function of the loudspeaker system to be optimized by applying
a test signal to the loudspeaker system
and sensing with a microphone the acoustic signal emitted by the loudspeaker system to provide measurement values that are processed to determine the transfer function;
generating and optimizing executable program instruction code for a DSP algorithm in the case of a previously set maximum deviation from the desired transfer function, the fewest DSP resources are needed;
loading the optimized executable program instructions in a digital signal processor.

2. Method according to claim 1, where the executable program instructions for the DSP algorithm are selected from a library of DSP algorithms.

3. Method according to claim 1, where the optimization of the code is performed in such a manner that, alternatively or in combination,
it is recognized whether, in the case of the selected algorithm, symmetries exist with respect to filter coefficients, in which case the code is optimized so that coefficients that appear twice must be stored only once in the data storage device, in order to optimize the storage device;
it is recognized whether, in the case of a stereo measurement, the measured transfer function of both channels is nearly equal and thus may be corrected by two identical filters/equalizers, in which case the code is optimized so that common coefficients are used for multiple channels;
it is recognized whether it is more favorable by the available resources to place coefficients for the selected algorithm either into data RAM or into program RAM.

4. Method according to claim 1, where the optimization of the code is performed recursively in multiple passes without further measurement-value determination.

5. Method according to claim 1, in which additional measurements are performed with reference to which the changed transfer behavior of the loudspeaker system is tested and the executable program instructions are confirmed, rejected, or changed accordingly.

6. Method according to claim 1, where the optimization of the code is performed starting from the information on the available resources.

7. Method according to claim 1, where the steps of determining, and generating and optimizing are performed in a common computational unit.

8. Arrangement for optimizing the transfer behavior of loudspeaker systems in a consumer electronics device with a microphone, a measurement unit, a DSP code generator, and an interface, wherein the microphone captures an acoustic test signal reproduced by a loudspeaker system of a consumer electronics device, converts it into an electrical measurement signal, and forwards it to the measurement unit, where, in the case of the measurement unit, the transfer function of the loudspeaker system is determined from the measurement signal and prepares it for the DSP code generator, wherein the DSP code generator generates, from a plurality of possible DSP algorithms, a code for a DSP algorithm that needs the fewest DSP resources in the case of a previously set maximum deviation from the desired transfer function, and wherein the interface loads the generated DSP code into the connected consumer electronics devices.

9. Arrangement according to claim 8, further comprising a library of codes of possible DSP algorithms from which the DSP code generator selects codes.

10. Arrangement according to claim 8, further comprising information on available resources of the DSP in the connected consumer electronics devices.

11. Arrangement according to claim 8, further comprising a user interface for input of information on available resources of the DSP.

12. Arrangement according to claim 8, where instead of an individual microphone, an array of microphones that are connected to the measurement unit by a multiplexer (260).
